(19) United States
(12) Patent Application Publication
(10) Pub. No.: US 2006/0200527 A1
(43) Pub. Date: Sep. 7, 2006

(54) SYSTEM, METHOD, AND COMPUTER PROGRAM PRODUCT FOR COMMUNICATIONS MANAGEMENT

(76) Inventor: Michael E. Woods, Tiburon, CA (US)

Correspondence Address: MICHAEL E. WOODS;PATENT LAW OFFICES OF MICHAEL E. WOODS, 112 BARN ROAD, TIBURON, CA, 94920-2602, US

(21) Appl. No.: 11/307,054

(22) Filed: Jan. 20, 2006

Related U.S. Application Data
(60) Provisional application No. 60/593,502, filed on Jan. 20, 2005.

(51) Int. Cl. G06F 15/16

(52) U.S. Cl. 709/206

(57) ABSTRACT

The system, method, and computer program product includes a first destination mail server for receiving a plurality of e-mail messages addressed to a first E-Mail address, the first destination mail server creating an action list digest of the plurality of e-mail messages and forwarding the action list digest to a second E-Mail address; and a second destination mail server for receiving the action list digest and permitting a reply of the action list digest from the second destination mail server to the first destination mail server to include control directives for processing of the e-mail messages on the first destination server identified in the action list digest. The invention may also be extended to other communications networks including standard telephone (POTS, PSTN), cellular, and wireless, broadband communications systems.

### BACKGROUND

The present invention generally relates to communications messaging systems, and more particularly to computer-managed communications networks (e.g., the Internet, the World-Wide Web (web), public switched telephone network (PSTN), and cellular telephone networks), and more specifically, the present invention relates to interpersonal messaging systems (e.g., electronic mail (e-mail) and cellphones).

The past decade has been marked by a technological revolution driven by the convergence of the data processing industry with the consumer electronics industry. The effect has, in turn, driven technologies that have been known and available but relatively quiescent over the years. An important one of these technologies is the Internet or Web related distribution of documents. The Web or Internet, which had quietly existed for over a generation as a loose academic and government data distribution facility, reached “critical mass” and commenced a period of phenomenal expansion. With this expansion, businesses and consumers have direct access to all matter of documents and media through the Web, and access to an alternative message delivery system. Also, as a result of the rapid expansion of the Web, E-Mail, which has been distributed for over twenty-five years over smaller private and specific purpose networks, has moved into distribution over the Web because of the vast distribution channels that are available and the ease and portability of use of this type of distribution.

The availability of extensive E-Mail distribution channels has made it possible to keep all necessary parties in business, government and public organizations completely informed of all transactions that they need to know about at almost nominal costs. However, there can be too much of a good thing. The availability of inexpensive E-Mail has led to a proliferation of E-Mail that many executive, management, professional and technical individuals believe is undesirable as they are forced to handle this seemingly unending deluge of messages.

This proliferation is not necessarily detrimental in all instances. Attendant to this proliferation is an increasing reliance upon the availability and access to E-Mail distribution systems because of some of the advantages of e-mail including speed and versatility. As E-Mail distribution systems begin to be used and relied upon for critical, important, or just desirable distributions of information, it becomes increasingly important that the infrastructure be in place and be operational for accessing this information. Unfortunately, current E-Mail distribution systems do not provide users with any direct mechanism to confirm easily whether their desired levels of actual availability and access are present for their e-mail system.

For some users a significant amount of time (and as the information in a E-Mail message or stream of messages becomes important or critical this amount of time that must lapse before it is fact “significant” decreases) may lapse before problems are detected. The awareness of the user may depend upon many factors, including: (i) an average quantity of E-Mail communications received over any given period, (ii) an ability of a user to perceive changes in the received quantity, and (iii) recognition that certain changes in the apparent quantity reduction are an indication of a problem in the availability and access to an E-Mail Distribution system. In some cases, the problem may not be brought to the user's attention until after much later beyond the window of significance. In some cases, an outside agency may use an alternate communication system (e.g., telephone) to contact the user about the problem or in more serious situations, about a failure of the user to respond to an E-Mail message or initiate some action in response to the E-Mail message.

For users who suspect a problem with availability and access, there is no convenient mechanism to verify or quantify the level or degree of availability/unavailability and access (though in many cases the situation is binary—either it “works” or not. However, in some cases a system may partially work for example by (i) accessing internal E-Mail and not accessing external E-mail, (ii) receiving e-mail messages but not sending e-mail messages. A user may send a sample message to another user/account, asking for a return response. The user may request, via a separate communications system, a test message from another user/account. While there are many problems with these troubleshooting activities, significant problems include that the user must be proactive to initiate such tests, and the tests, even at their best, are time-consuming and inconvenient to perform.

Many current E-Mail distribution systems provide routine physical layer checks to a next-in-sequence distribution device of the E-Mail distribution system. For example, most E-Mail distribution clients will notify a user when a network connection/telephone line is unavailable, or when necessary access/login credentials are incorrect. Unfortunately, because of the expanse and decentralization of many functions, pathways, routings, and other components of E-Mail distribution systems, such nearest-neighbor physical layer checks are insufficient to wholly answer whether the user has functional availability and full access to the desired E-Mail distribution system.

There are also systems that may be adapted to assist in troubleshooting E-Mail distribution systems, at least for those knowledgeable and initiative users who invest the necessary time to do this and exert themselves. For example, some systems may permit entry of an E-Mail address for a user (e.g., a return address in a receipt request) such as by initiating transmission of an E-Mail message to a remote process and then causing the remote process to issue an E-Mail test message to the return E-Mail address. Or, a user may telephone another user and request test messages. Because the user does not control precisely the content and timing, some ambiguity is added into the testing so that a failure to receive and/or recognize a received message cannot necessarily indicate a problem. As the user continues to test and request more messages, important time is consumed and otherwise useless messages (the test message) accumulate in the e-mail client that can interfere with locating and responding to non-testing messages.

The availability of extensive E-Mail distribution channels has made it possible to keep all necessary parties in business, government and public organizations completely informed of all transactions that they need to know about at almost nominal costs. However, there can be too much of a good thing. The availability of inexpensive E-Mail has led to a proliferation of E-Mail that many executive, management, professional and technical individuals believe is undesirable as they are forced to handle this seemingly unending deluge of messages.

E-Mail users also experience another quandary, namely whether to implement various security precautions when transmitting their E-mail messages to another party. It is known that various cryptographic systems may be employed to secure E-mail transmissions over public networks as an aid to limit access to the message contents by anyone other than the intended receipient(s). While these systems are generally very good, most of them require a fairly sophisticated and technically savvy individual to properly set-up, use, and maintain. For example, a very good and relatively popular message securing system is the use of public/private pair encryption. In these systems, a user establishes a pair of keys of sufficient strength secured with appropriate passphrases. A key is deciding what is sufficient strength and what is an appropriate passphrase. The more sufficient and appropriate, the more cumbersome it is for a user to effectively manage their keys without compromising the promised protection. And a user who obtains these keys must then make the public key available to prospective users desiring to send an encrypted message. This further decreases the ease of use.

However, when a user desires to send a secured communication to another user, if that prospective user has not established a public/private key and made the public key information available, the user cannot send the protected communication. So a user desiring to use secured communication must go through the key generation process but must also have its recipients also go through the key generation process. The subsequent challenge of adequately performing these steps and exchanging the appropriate information is challenging enough without the further additional difficulty that for many users encrypted messaging is used infrequently that necessary passphrases and passwords for converting encrypted text to cleartext are easily forgotten. Needless to say that the procedures and tools, while they have improved greatly over the years, are still fairly cryptic to even experienced users. Thus, many less technical or inexperienced users forego use of encryption in common message tasks. It in the current situation among many users, it is not enough that the possessor of a message desire to protect its content. The user must prevail on prospective recipients to install and use the current procedures for encryption. Without convincing others to create, maintain, and use encryption systems, the sender must either send cleartext (also called plaintext) or forego transmission of messages.

Users of E-Mail systems have another problem that can become difficult to manage—SPAM. SPAM is a common term used to denominate unwanted messages (e.g., unsolicited marketing or various fraud messages) that are too often sent to a user's E-Mail address. There are many mechanisms for extracting a user's legitimate E-Mail address from common network related activities as are well-known. Conventional measures that have been developed are various filters, rules, access lists and the like designed to automatically sort messages between “good” and “bad” messages. A difficulty is that these determinations can be largely subjective and it can be difficult to have a system that works flawlessly in all cases. Over-aggressive controls remove wanted messages and under-aggressive systems let unwanted messages through. Some users use a hybrid approach but customizing and adjusting settings is difficult and time-consuming. Also, there is a profitable business in gathering valid E-Mail addresses and presenting mass-marketing messages to as many people as possible, so there are a group of people actively working on defeating the controls and limits on testing and gauging a message's suitability.

As stated above, systems like this require a degree of initiative and technical expertise from the user to activate such tests. Further, such systems only inferentially indicate an error, above the immediate physical link layer, upon failure of a return receipt E-Mail message or lack of receipt of an expected message. Further, the proliferation problem noted above makes many users of E-Mail distribution systems reluctant to further increase a volume of received messages in their chosen E-Mail message collection/reading mechanism/process as it continues to degrade and erode non-testing uses.

Thus, conventional procedures are not solutions to the problems described above. It would be beneficial to simply and efficiently solve these problems with the prior art to provide a mechanism that easily verifies and/or validates a desired communications channel, such as an E-Mail delivery system or telecommunications system.

### BRIEFSUMM

The present invention provides an electronic mail distribution system for a network, e.g. Internet E-Mail transmitted between interactive display terminals. The invention offers a solution to the above problems by providing, in a communication network with user access via a plurality of communications devices, a distribution system for communications transmitted between the devices. The system includes a first destination mail server for receiving a plurality of e-mail messages addressed to a first E-Mail address, the first destination mail server creating an action list digest of the plurality of e-mail messages and forwarding the action list digest to a second E-Mail address; and a second destination mail server for receiving the action list digest and permitting a reply of the action list digest from the second destination mail server to the first destination mail server to include control directives for processing of the e-mail messages on the first destination server identified in the action list digest.

The present invention includes apparatus, methods and computer program products for preparing, processing, and maintaining digests, access lists and other mail control mechanisms using messaging exchanged between a SPAM control address system and a protected address system. Implementations of the preferred embodiment are used as an aid for a subscriber to receive a summary account of pending e-mail messages without actually implementing and using a message retrieval system, such as by preparing and sending a digest to a fax number or PDA device. The system may provide alerts and other messaging based upon processing rules and configuration information determined by a user. Such as sending a page when certain messages appear in the protected e-mail address space.

### DESCDRAWINGS

The present invention will be better understood and its numerous objects and advantages will become more apparent to those skilled in the art by reference to the following drawings, in conjunction with the accompanying specification, in which:

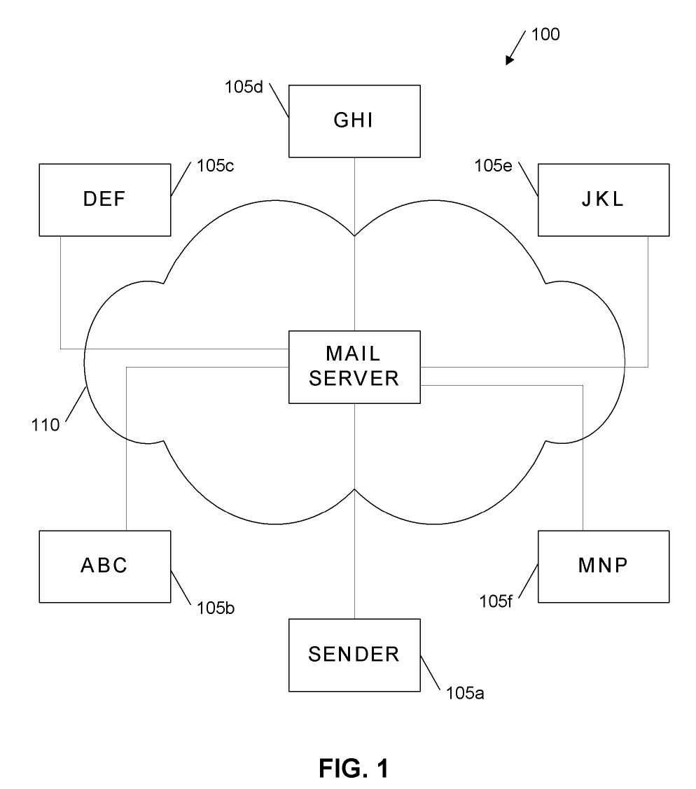

FIG. 1 is a schematic view of a computer network, implementing a preferred embodiment of the present invention;

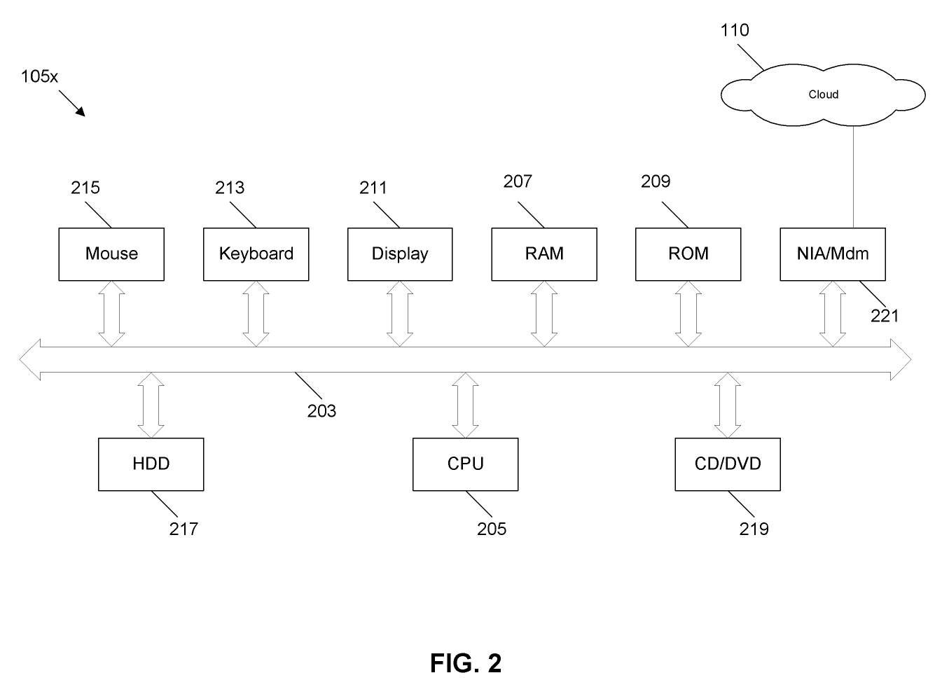

FIG. 2 schematically illustrates the main components of a generic computer of the network shown in FIG. 1;

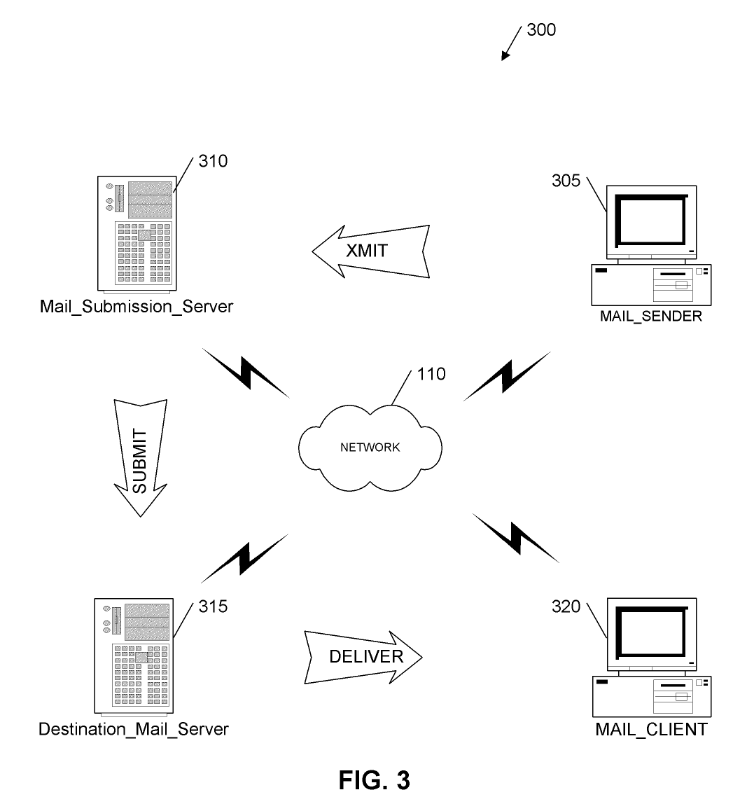

FIG. 3 is a second generalized view of an E-Mail distribution system in a network environment that may be used in the practice of the present invention;

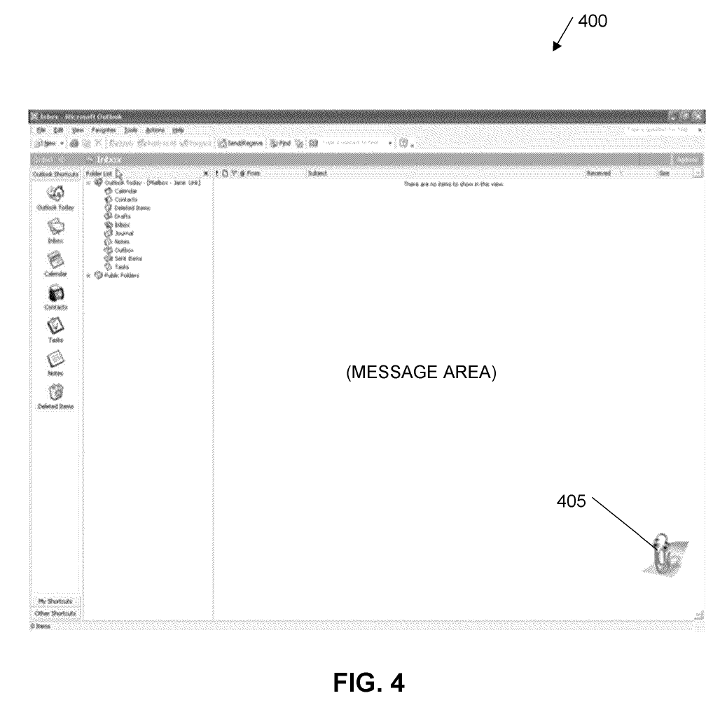

FIG. 4 is a representation of one example of an interface element for a client;

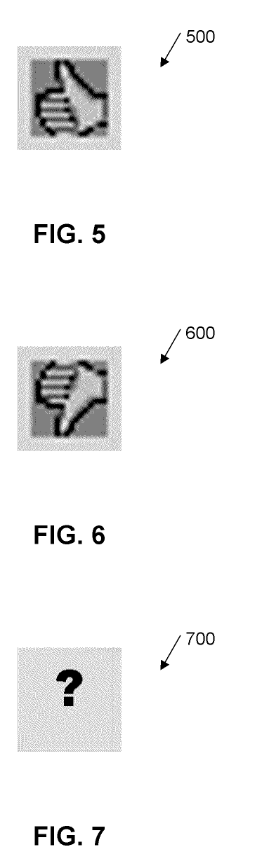

FIG. 5 illustrates an “OK STATUS” indicator;

FIG. 6 illustrates a “FAIL STATUS” indicator;

FIG. 7 illustrates an “UNKNOWN STATUS” indicator;

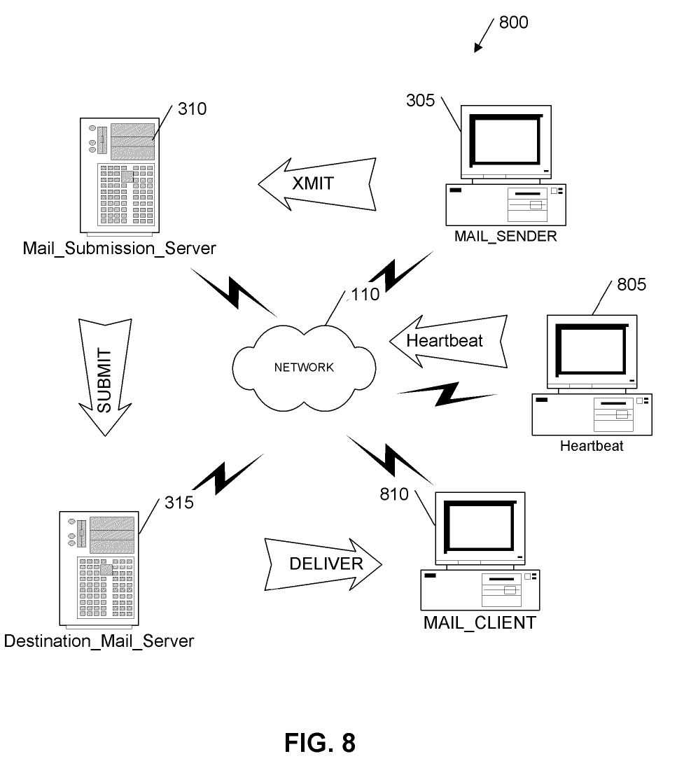

FIG. 8 is a generalized view of an E-Mail Channel distribution and verification system in a network environment implementing a preferred embodiment of the present invention;

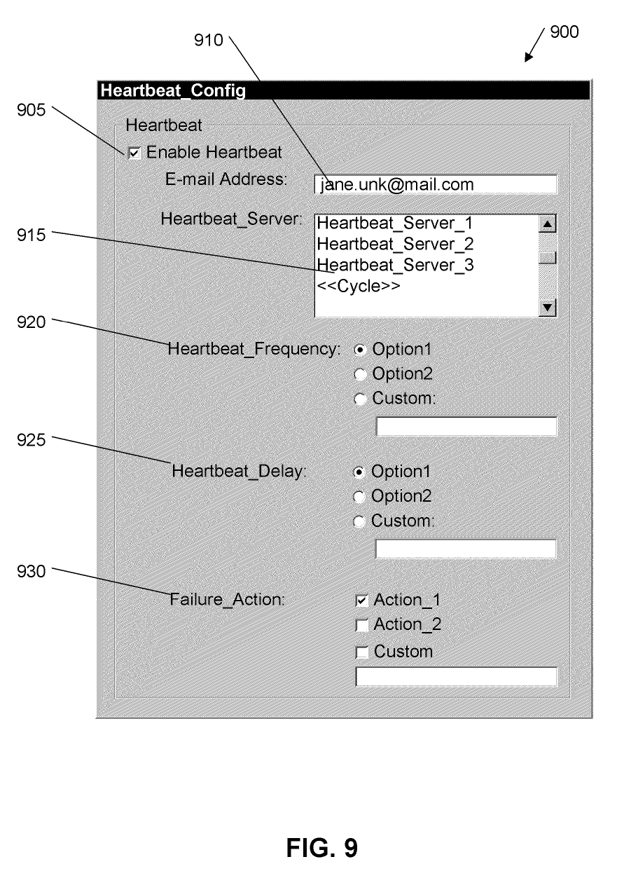

FIG. 9 is an interface element depicting but one example of a possible set of configuration options for a preferred embodiment of the present invention;

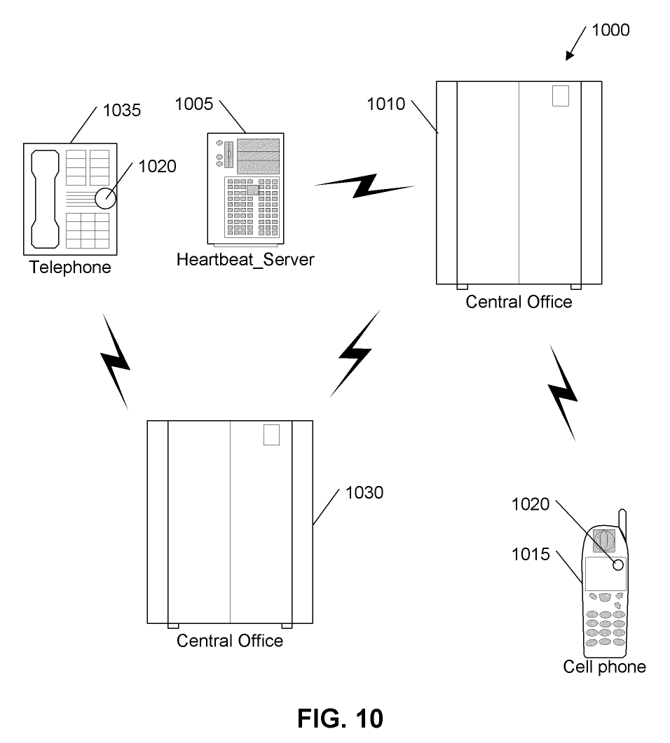

FIG. 10 is a generalized view of a telecommunications channel calling and verification system in a network environment implementing a second preferred embodiment of the present invention;

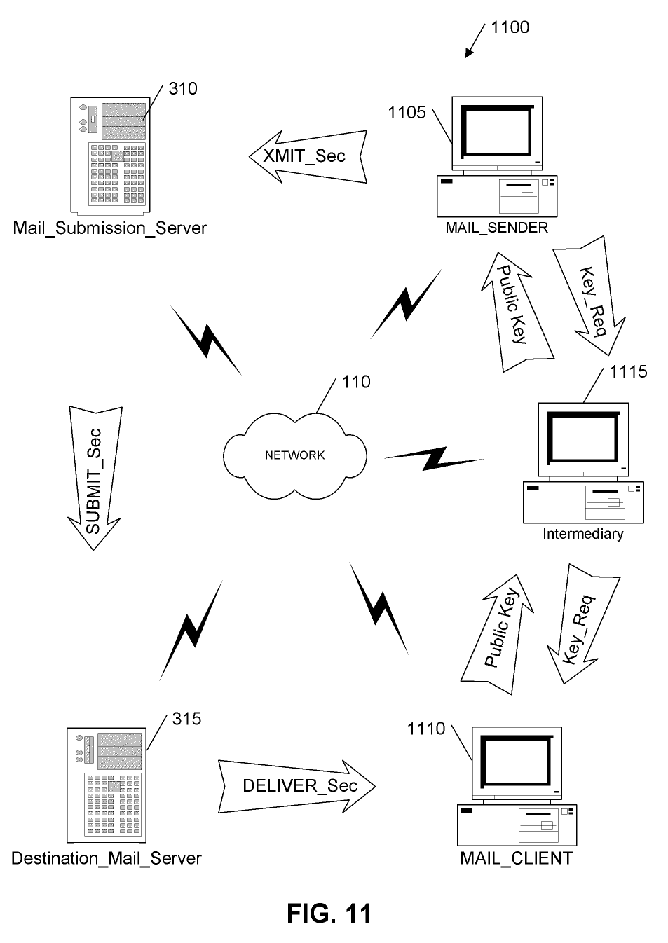

FIG. 11 is a generalized view of a secured E-Mail communications system according to a preferred embodiment of the present invention;

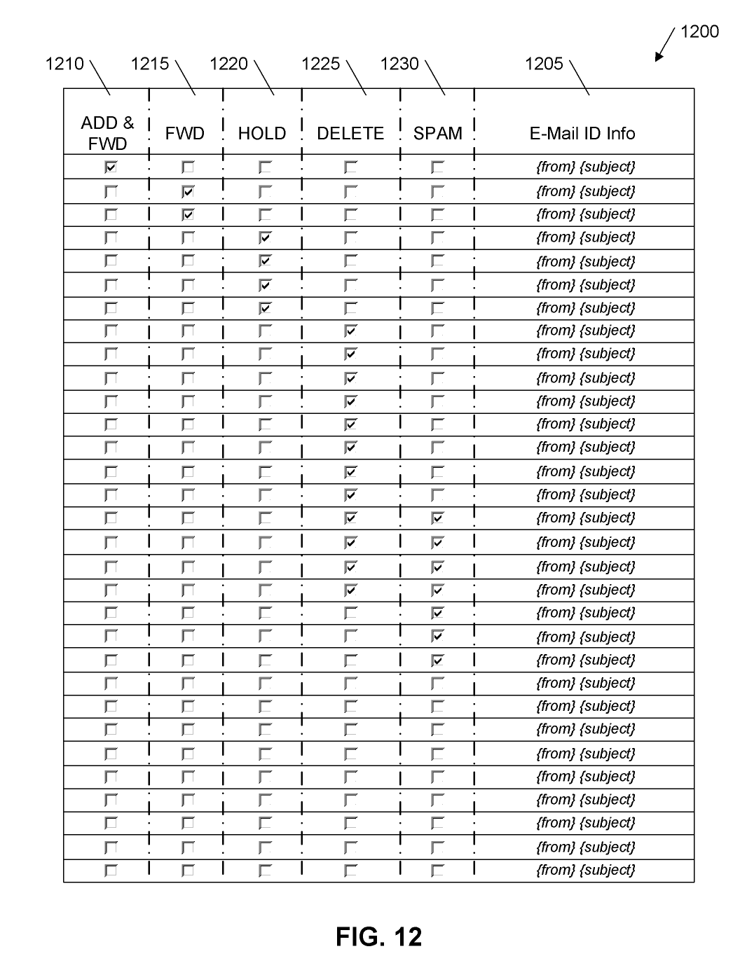

FIG. 12 is a summary E-Mail Action list according to a preferred embodiment of the present invention; and

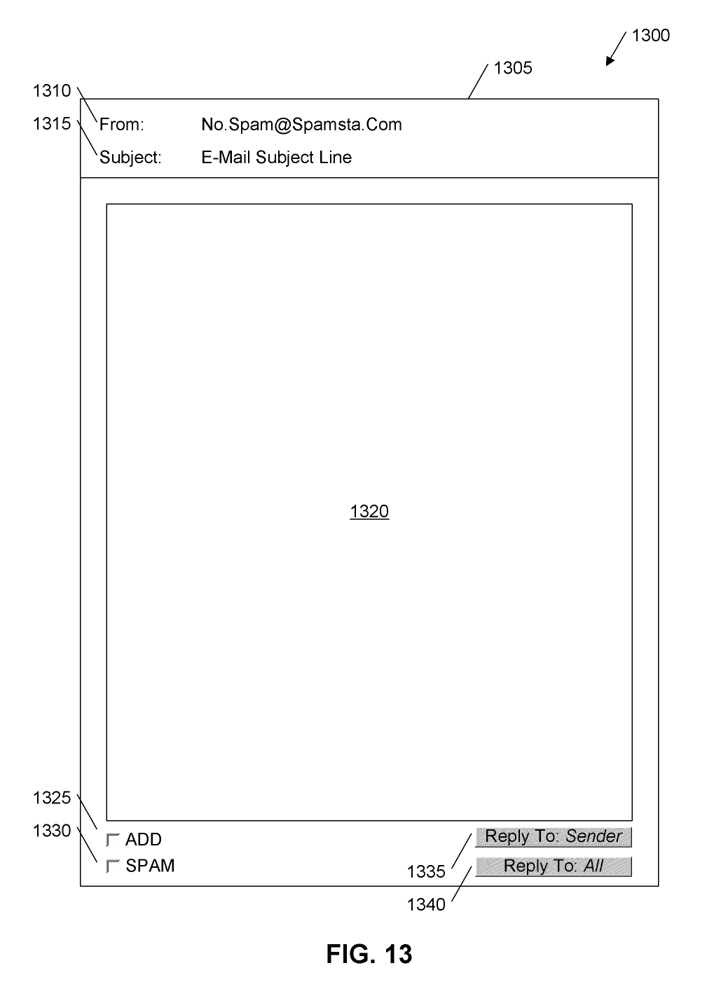

FIG. 13 is a generic E-Mail message forwarded to a subscriber according to a preferred embodiment of the present invention.

### DETAILEDDESC

The present invention relates to an efficient communications channel verification solution that provides a user with simple and quick confirmation of the actual availability of communications across a plurality of locations, and one that may be easily used without complicated or time-consuming configuration options. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein. As the present invention is applicable to many different types of communications systems, the following description simplifies explanation by explaining the invention in terms of e-mail distribution systems and telephone networks. The invention may be simply adapted and extended for other communications systems.

With reference to the drawings, in FIG. 1 a distributed data processing system or computer network 100 is schematically shown. The computer network 100 may be for example a local area network (LAN), a metropolitan area network (MAN), a wide area network (WAN) or a network of networks such as the Internet, and comprises a plurality of computers 105a-105f interconnected to each other by means of a data communication infrastructure 110.

As schematically shown in FIG. 2, a generic computer of the computer network 100, e.g. the computer 105a, includes several functional units connected in parallel to a data communication bus 203, for example of the PCI type. In particular, a Central Processing Unit (CPU) 205, typically comprising a microprocessor, controls the operation of the computer 105a, a working memory 207, typically a RAM (Random Access Memory) is directly exploited by the CPU 205 for the execution of programs and for temporary storage of data, and a Read Only Memory (ROM) 209 stores a basic program for the bootstrap of the computer 105a. The computer 105a comprises several peripheral units, connected to the bus 203 by means of respective interfaces. Particularly, the peripheral units that allow the interaction with a human user are provided, such as a display device 211 (for example a CRT, an LCD or a plasma monitor), a keyboard 213 and a pointing device 215 (for example a mouse or a trackpoint). The computer 105a also includes peripheral units for local mass-storage of programs (operating system, application programs) and data, such as one or more magnetic Hard-Disk Drivers (HDD), globally indicated as 217, driving magnetic hard disks, and a CD-ROM/DVD driver 219, or a CD-ROM/DVD juke-box, for reading/writing CD-ROMs/DVDs. Other peripheral units may be present, such as a floppy-disk driver for reading/writing floppy disks, a memory card reader for reading/writing memory cards and the like. The computer 105a is further equipped with a Network Interface Adapter (NIA) card 221 for the connection to the data communication network 110; alternatively, the computer 105a may be connected to the data communication network 110 by means of a MODEM.

Any other computer 105b, . . . , 105f in the computer network 100 has a structure generally similar to that depicted in FIG. 2, possibly properly scaled depending on the machine computing performance.

The computer network 100 supports an electronic mail (shortly, e-mail) service, enabling users of the computers 105a-105f to exchange e-mail messages. The details of the e-mail service are known per-se and will not be described in depth. Different e-mail addresses identify different users who are subscriber to the e-mail service; by way of example, in the following it will be assumed that e-mail service is an Internet e-mail service, in which an e-mail address takes the form “user@host.domain”, and that the users ABC, DEF, GHI, JKL, MNP of the computers 105b to 105f have respective e-mail addresses “abc@xy.com”, “def@xy.com”, “ghi@zw.com”, “jkl@zw.com”, and “mnp@qr.net”.

One or more computers 115 in the computer network 100 act as e-mail server computers (shortly, mail servers), also known as mail transfer agent, managing the distribution of e-mail messages coming from different users to the intended recipients. When a user desires to take advantage of the e-mail service, he/she has to preliminary subscribe for this service at a mail server; an e-mail account is opened at the mail server for the new subscriber, an e-mail address is assigned thereto, and a mailbox is created. Typically, e-mail messages addressed to a given e-mail address are stored in the mailbox of the mail server holding the corresponding account, until the subscriber user connects to the mail server and downloads the messages from the mailbox. Similarly, when a subscriber user desires to send an e-mail message to one or more other subscribers, the user composes the e-mail message and sends the message to the respective mail server, which then delivers the message to the recipients, according to the e-mail addresses specified in the message (as will be described later on).

When, for example, the user of a computer 105a (the sender) intends to send an e-mail message to one or more of the users of the computers 105b-105f (the recipients ABC, DEF, GHI, JKL, MNP), the computer 105a sends the message to the respective mail server 115; based on the e-mail addresses of the message recipients, the mail server 115 then delivers the e-mail message to the proper mail servers of the intended recipients. Each mail server holds, for each of the respective subscriber users, a mailbox of incoming e-mail messages; by connecting to the mail server, the user downloads the messages in the respective mailbox, though sometimes the mailbox is included on a local computer system or other times on a remote computer system.

In order to interact with the respective mail server, in each of the computers 105a-105f an e-mail client software is installed. The e-mail client software, when running on a computer, acts as a mail user agent, which interacts with the mail transfer agent. The e-mail client software is invoked whenever the user of the computer desires to send an e-mail message or to connect to the respective mail server, so as to download and display the e-mail messages addressed to the e-mail consumer.

Before going further into the details of specific embodiments, it will be helpful to understand from a more general perspective the various elements and methods that may be related to the present invention. Since a major aspect of the present invention is directed to systems for the transmission of E-Mail documents over networks, an understanding of networks and their operating principles would be helpful. This description does not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers. E-Mail is distributed through such a network. Operating systems may directly support e-mail functions, or directly support applications/processes that directly support e-mail functions (e.g., a dedicated e-mail client like Qualcomm's Eudora or Microsoft's Outlook, or may support e-mail clients embedded in other applications like a Web Browser. In some instances e-mail messages are received locally and in others a local client/process is a viewer into a remote client that holds and stores e-mail messages. Some or all of these components may be on a local computer system, a local network or other remote networks or on the Internet or Web. Also, the present invention distinguishes between a mail_client and a user and a consumer. These are different functions that may be combined together in different configurations or numbers. A single user may operate multiple mail_clients for one or more sets of e-mail messages. In some cases, mail_clients may exist with a specifically identified user or consumer, or the user may be a virtual user or administrative/management process that processes e-mail messages without direct human interaction.

The following few paragraphs provide a basic overview of some of the components and functionality of an e-mail delivery system in one possible arrangement and configuration: E-mail (electronic mail) includes an exchange of computer-stored messages by telecommunication. (Sometimes it is referred to as email; the following discussion uses e-mail.) E-mail messages are usually encoded in ASCII text. However, a user may also send non-text files, such as graphic images and sound files, as attachments sent in binary streams. E-mail was one of the first uses of the Internet and is still the most popular use. A large percentage of the total traffic over the Internet is e-mail. E-mail can also be exchanged between online service provider users and in networks other than the Internet, both public and private. E-mail may be distributed to lists of people as well as to individuals. A shared distribution list may be managed by using an e-mail reflector. Some mailing lists allow you to subscribe by sending a request to the mailing list administrator. A mailing list that is administered automatically is called a list server. E-mail is one of the protocols included with the Transport Control Protocol/Internet Protocol (TCP/IP) suite of protocols. A popular protocol for sending e-mail is Simple Mail Transfer Protocol and a popular protocol for receiving it is POP3. Both Netscape and Microsoft, among other manufacturers, include an e-mail utility within their Web browsers.

Billions of electronic mail (e-mail) messages move across the Internet every year. Sending electronic letters, pictures and data files, either across a building or across the globe, has grown so popular that it has started to replace some postal mail and telephone calls. This universal medium is no longer restricted to exchange of simple text messages and is now regularly used to deliver voice mail, facsimiles and documents that may include images, sound and video. Typically, a message becomes available to the recipient within seconds after it is sent—one reason why Internet mail has transformed the way that we are able to communicate.

FIG. 3 is a second generalized view of an E-Mail distribution system 300 in a network environment that may be used in the practice of the present invention.

1. A MESSAGE SENDER 305 uses mail software, called a client, to compose a document, possibly including attachments such as tables, photographs or even a voice or video recording. FIG. 4 is a representation of one example of an interface element for a client 400 (in this case client 400 is represented by an e-mail client interface available in Microsoft's Outlook client). System software, called Transmission Control Protocol (TCP), divides the message into packets and adds information about how each packet should be handled-for instance, in what order packets were transmitted from the sender. Packets are sent to a mail submission server 310, a computer on the internal network of a company or an Internet service provider for example.

2. INTERNET MAIL ADDRESSES, as discussed above, attached to each message are in the form “mailbox@domainname”—one specific example being “webmaster@corp.com.” The multipart domain name in the above example denotes a top-level domain (“.com”) following the second-level domain (“corp”). A message is delivered to an individual or a group by the mailbox name (“webmaster”).

3. MAIL SUBMISSION SERVER 310 converts the domain name of the recipient's mail address into a numeric Internet Protocol (IP) address. Querying domain name servers (not shown) interspersed throughout the network/Internet does this conversion. For example, the mail submission server may first request from the “root” name server the whereabouts of other servers that store information about “.com” domains (a). It then interrogates the “.com” name server for the location of the specific “sciam.com” name server (b). A request to the “sciam.com” name server provides the IP address for the computer that receives the mail for sciam.com, which is then attached to each message packet (c).

4. ROUTERS (also not shown) dispersed throughout the Internet read the IP address on a packet and relay it toward its destination by the most efficient path. (Because of fluctuating traffic over data lines, trying to transmit a packet directly to its destination is not always the fastest way.) The packets of a single message may travel along different routes, shuttling through ten or so routers before their journey's end.

5. A DESTINATION MAIL SERVER 315 places the packets in their original order, according to the instructions contained in each packet, and stores the message in the recipient's mailbox. A mail client 320 (e.g., client 400) may then acquire/access and display the message. The software used by the mail_sender and the mail_client may be the same, similar, or drastically different. For purposes of the following discussion, the MAIL_CLIENT is shown in FIG. 4 in which received messages are listed (sometimes with a preview or thumbnail) in the message area. Other times, the message area includes lists of messages to be acted upon. Client 400 actually is a close representation of an interface element of Microsoft Outlook that includes a representative “Assistant” icon 405 that initiates a help system for Outlook. In the present invention, icon 405 also represents an indicator or feedback system 405 for visually indicating a condition of the user's e-mail system. One implementation provides for icon 405 to reflect a status condition as follows.

FIG. 5-FIG. 7 are representative status indication icons that may be used in conjunction with icon 405, for example. FIG. 5 illustrates an “OK STATUS” indicator 500, FIG. 6 illustrates a “FAIL STATUS” indicator 600, and FIG. 7 illustrates an “UNKNOWN STATUS” indicator 700 used when the embodiment has yet to determine whether to use indicator 500 or indicator 600. Indicator 500-indicator 700 may be used as part of icon 405, or integrated into a toolbar or other structure of client 400 or messaging feature, or in a structure of the operating system or other application/process supported by the operating system. For example, Windows XP, like many other versions of Windows, includes an application bar and status tray in which various functions, features, and status indicators are presented to a user to monitor applications and processes on a computer system. The indicators may be presented, as appropriate, in this system tray area of the operating system. While the indicators described above are shown as visual indication elements, other indication systems may also be used in cooperation or in lieu of (including aural cues to present status information to the user). Different users are able to customize various thresholds associated with the various indicators as described further below.

FIG. 8 is a generalized view of an E-Mail Channel distribution and verification system 800 in a network environment implementing a preferred embodiment of the present invention. Similar to system 300 shown in FIG. 3, system 800 operates to exchange e-mail messages in conventional fashion. In addition to the components and functions described in cooperation with the elements of system 300, system 800 includes a heartbeat server 805. Heartbeat server 805 periodically issues predetermined e-mail-like messages (referred to herein as heartbeats) specially destined for a heartbeat-enabled MAIL_CLIENT 810. Depending upon whether predetermined thresholds are satisfied (as determined by server 805 and/or client 810) generator 805 and/or client 810 may each independently or cooperatively determine that one or more components of system 800 are not working. Server 805 may, in some configurations, also receive heartbeats from other servers or clients and it may receive other communications including echo_heartbeats.

As discussed above, system 300 may fail to deliver messages from sender 305 to client 320—(Note it is typical during 2-way communications for a computer system (e.g., 305) to switch roles and take on another function (e.g., become a “client” rather than a sender). It is possible for a system 300 to work in one configuration and not work in the “reversed” direction due to different pathways and configuration elements. System 800 provides a user with an ability to determine whether either or both “directions” are actually functioning.

Many clients 320 have an ability to detect very simple failures. For example, when a physical link is absent (a missing network cable or no dial tone for example), many clients provide feedback that a connection is not possible. However, a capability of one component of system 300 to establish a basic physical connection to its next-nearest neighbors does not guarantee that messages may be properly delivered or that the entirety of system 300 is operational. Part of the difficulty is that system 300 is replicated for millions to billions of connections and each pathway from a sender to a receiver may define a unique system 300 as to any pair of senders and receivers. Often a single set of machines support these myriad “virtual” systems 300 and as between many pairs passing through the same physical system, each may have a different operational status. Sometimes the variations are dependent upon individual configurations, sometimes on local (e.g., on a component or element a receiver may directly physically access) and sometimes it may be remote (non-local). Whatever the reasons may be, it is the case that the physical structures may all appear to be operating normally yet e-mail message are unable to propagate as described above from a sender to the client. Users have different tolerances for e-mail disruption and system 800 permits users having critical need of their e-mail system 800 to be kept apprised as frequently as necessary regarding the then-current status of an ability of system 800 to actually deliver an e-mail message.

System 800 does this by sending client 810 a periodic heartbeat through the e-mail components. The heartbeat, being sufficiently e-mail-like, propagates just like an e-mail message would and success or failure of the heartbeat reflects the likelihood that real e-mail messages will be able to propagate to client 810. A key difference between heartbeats of the present invention and actual e-mail messages is that client 810 recognizes these as heartbeats and does not present them to the user for review, the message area does not fill up with these messages, client 810 may immediately discard these heartbeats without user intervention so that resources of the user are not used and it does not interfere with the operation of system 800 in presenting real e-mail messages. (Of course in some embodiments, some users may desire or accept heartbeats that are actual recorded messages in the user's “inbox”—such as when the heartbeats include performance metrics for user review—but that is not preferred). In a simple embodiment, a heartbeat may be a special e-mail message tagged by a specific sender address, subject, and/or message content so that it actually accurately emulates an e-mail message yet client 810 may automatically discard it without putting it in the inbox (or even into a “discard” or “garbage” subfolder of the inbox.)

Thus, system 800 continuously and reproducibly issues these heartbeat signals destined for client 810 on a predetermined schedule. As long as heartbeats are received as scheduled, client 810 actuates indicator 500 to indicate system 800 is working properly. When a failure condition is detected, client 810 actuates indicator 600 to apprise the user of a failure in the communication channel. Until client establishes the condition of system 800, indicator 700 is actuated.

As noted above, sender and client roles are reversible in system 300 and system 800 supports this as well. In the case of monitoring for or detecting faults with an ability of client 810 to actually send e-mails out to a sender 305, client 810 may be enabled to generate heartbeats and to send them to heartbeat server 805 on a predetermined schedule. As long as heartbeats generated by client 810 arrive at server 805 as scheduled, server 805 establishes that e-mails transmissions for client 810 (send mail) are viable. However, in the event of a failure, server 805 may be able to communicate the failure directly to client 810 (as noted above, failures may in some circumstances be asymmetric) or server 805 may need to use an alternate communication channel (e.g., fax, pager, phone line, alternate e-mail address or the like) to notify a user or a user agent.

Depending upon implementations and needs of users or administrators of system 800, many different combinations or features may be made. For example, heartbeats may contain timing/routing/propagation data or other information that could be important to a user, administrator, or client 810 and these data or information may be monitored for performance related information beyond simply establishing whether minimal performance levels. Additionally, server 805 and client 810 may maintain a dialog with each other that monitor the other and passes status or other metric information between them to collectively establish a health and status of various features of system 800. For example, at various times (or periodically) server 805 may generate a special action_heartbeat to client 810 to initiate some particular function (like a return heartbeat of a certain type that is referred to herein as an echo_heartbeat). Or, client 810 may do the same. Depending upon the response, if any, various conditions of system 800 may be revealed to one or both of server 805 and client 810. As appropriate, these components individually react or provide indications/notifications depending upon configuration information. In some systems, placing servers 805 at various locations in a distributed network, an accurate “map” may be developed through monitoring where and which heartbeats are generated and actually consumed by the various components. Associating servers 805 with various network segments and/or network components gives a direct feedback when heartbeats from those servers are detected/consumed by a client (which may also be distributed throughout the communications network).

FIG. 9 is an interface element 900 depicting but one example of a possible set of configuration options for a preferred embodiment of the present invention. Interface element 900 is associated with client 810 and permits a user to customize client 810 insofar as its response and handling of heartbeats is concerned. A first option 905 enables/disables heartbeats for client 810. When enabled, interface 900 exposes/activates the other options as shown in FIG. 9. Interface 900 includes an address field to designate an e-mail address to which server 805 is to send heartbeats. Interface 900 provides the user with an ability to access a particular heartbeat server 805 to use in sending the heartbeats. Sometimes geographic location or specific backbone connections may affect e-mail system 800 negatively or be required to better duplicate any given user's e-mail delivery system so system 800 may include heartbeat servers 805 in different representative locations and/or on different physical backbones. A user may select one or more servers or request that all the servers be used (e.g., cyclically). Heartbeat server listbox 915 includes the available heartbeat servers/options. A first option set 920 provides the user with an ability to set a frequency of heartbeat generation (e.g., by server 805). Some standard options are provided and in some cases a user may be provided the ability to enter in a desired frequency. For example, option 1 may be one heartbeat per fifteen minutes, and option 2 may be one heartbeat per five minutes. A related second option set 925 provides the user with an ability to set a threshold for an amount of delay before an error condition is satisfied. For example, when first option set 920 indicates a heartbeat should be received at least one every fifteen minutes and more than fifteen minutes have elapsed since the last heartbeat, the value selected in option set two 925 establishes whether and to what degree late heartbeats are in fact considered late and therefore warrant actuation of indicator 600. Third option set 930 provides the user with some options to handle a heartbeat failure condition. Action 1 may include an audio/visual indicator, Action 2 may include actuation of an alternate communication channel to the user (e.g., e-mail may be broadband based so Action 2 may initiate a telephone call to a pager hotline.) The actions of option set 3 may be combined and used cooperatively, with a user choosing to have both an audio/visual indicator and actuation of an alternate communication channel message. The various parameters and values of the different option sets are established based upon a particular embodiment and implementation appropriate for the needs of the users, administrators and system 800 configuration details. In some instances, client 810 may have an automatic diagnostic mode (such as during a failure) in which specific diagnostics are activated. For example, when multiple servers 805 are strategically located throughout the network, client 810 may be able to cycle through them methodically to isolate and report where a problem resides. The use of a server 805 and client 810, particularly those that are able to generate echo_heartbeats provides an ability to do loopback testing of the communications network.

Interface 900 is described as associated with client 810 (which is the preferred embodiment for a single-user setup). In some cases, a network administrator may set up server 805 for many users and in which case interface 900 may be associated with server 805. Server 805 and client 810 may exchange various configuration information parameters to function effectively together. Also, the above description includes use of specifically addressed heartbeats (rather than generic “broadcast” heartbeats). In some instances, it may be appropriate and advantageous (for example in a LAN environment) to use broadcast heartbeats when such broadcast heartbeats may effectively provide similar functionality. By broadcast heartbeats, it is taken to mean that the heartbeat or the clients are configured or have their addresses masked in a way that multiple clients may react/respond to a single heartbeat.

FIG. 10 is a generalized view of a telecommunications channel calling and verification system 1000 in a network environment implementing a second preferred embodiment of the present invention. System 1000 provides an ability for a user of portable communications device (e.g., a cellular telephone, pager, personal digital assistant (PDA) and the like to also verify actual operation of a particular device. Just like in the example described above, portable communications devices often have a mechanism to determine whether certain minimal conditions are present (e.g., whether a sufficiently strong signal from a local cellular tower is detected) but not whether in fact communication events may in fact be exchanged with the communications medium. Thus, by extension from system 800, system 1000 includes a heartbeat server 1005 to periodically generate appropriate heartbeats suitable for the communication medium and communications device client. System 1000 also includes a communications station 1010 in a central office that communicates to a portable client 1015 using existing infrastructure. As long as client 1015 receives appropriate heartbeats, an indicator 1020 apprises a user of the status of communications network 1000. In this case, for client 1015 included in a cellular telephone, heartbeats are emulated phonecalls that do not cause the phone to “ring” but the presence of the heartbeat causes indicator 1020 to glow green (for example). Failure of the emulated call within the appropriate conditions causes indicator 1020 to glow red and indicator glows yellow for uncertain conditions. Just as described above, a user may potentially be communication with a local physical nearest-neighbor in the link, but beyond that link the system is not functioning and the user is unable to use the communications channel. Of course, other indication systems may be used in addition to or in lieu of the described green/red/yellow visual indicator.

System 1000 also includes a second central office communications device 1030 for relaying communications events to a telephone 1035 associated with a single physical location (e.g., a landline). Telephone 1035 is also provided with indicator 1020 so that a use may have a visible indication that the landline is actually enabled. As opposed to portable communications devices like cellular telephones, landlines are not equipped with standard with signal strength meters. A user of a conventional phone has no way of knowing, except for picking up a handset, as to whether the phone line is actually functioning. In such a case, indicator 1020 may also function as an external indicator to inform a user whether a dial tone is present by glowing green in response to periodic off-hook events when the dialtone is present. Users may thus be apprised of a potential problem in advance of picking up the telephone to make a call. This is in addition to or as an alternative to controlling indicator 1020 in cooperation with telephone 1035 as described above in cooperation with portable client 1015.

While basic concepts such as heartbeats and loopback have been available in network architectures for some time, these are often physical layer or link layer tests only or they are broadcast signals and not specifically checking whether a specific network component is present and functioning. In some cases, similar diagnostics may be able to be manually initiated but as noted above, a user either must be unduly proactive and periodically test a network or must develop a perception that “something” is wrong. The present invention provides a constant heartbeat to these communications clients to provide proactive problem detection without drawback to any single client. A user does not need to wonder whether a lack of any messages for some duration is an indication of a problem and the user does not have to process and sift through heartbeat messages overflowing in the user's inbox.

FIG. 11 is a generalized view of a secured E-Mail communications system 1100 according to a preferred embodiment of the present invention. System 1100 is designed to provide a user with a simple, convenient, and efficient mechanism to send secured communications to another user. In system 1100, a MAIL_SENDER 1105 is directed to encrypt and transmit a secured message to a MAIL_CLIENT 1110. SENDER 1105 and CLIENT 1110 may be set up to use almost any key, token, or other security paradigm but for purposes of the present invention, the following description implements a public/private key encryption system as well known. Conventional public/private key systems provide for SENDER 1105 and CLIENT 1110 to each have a public key and private key. SENDER 1105 uses the public key of CLIENT 1110 to create encryptedtext from a cleartext message and sends the encryptedtext to CLIENT 1110. CLIENT 1110, in well known fashion, decrypts the encryptedtext using the private key of CLIENT 1110 and results in production of the cleartext. In some systems, the private key of SENDER 1105 may be used as a digital signature that permits CLIENT 1110 to use the public key of SENDER 1105 to authenticate various attributes.

However, in system 1100 the mechanism is adjusted slightly. Each of SENDER 1105 and CLIENT 1110 include a local agent/process that communicates with an intermediary server 1115 that facilitates the creation and exchange of necessary encrypting/decryping data. In the case of the simple example of SENDER 1105 transmitting a secured message to CLIENT 1110, intermediary 1115 simply forwards a public key request from SENDER 1105 to CLIENT 1110 and provides the public key from CLIENT 1110 to SENDER 1105 as further described below. In the preferred embodiment, this exchange of public key requests and public keys is performed through an alternate communications channel other than use of the E-mail messaging system. For example, SENDER 1105 and CLIENT 1110 may each establish a secure sockets layer (SSL) direct communications channel to exchange this information outside the intended message transmission system.

Thereafter, SENDER 1105 uses the public key to create the secure message which is sent to CLIENT 1110 using the E-Mail message system described above. CLIENT 1110 uses its private key to decrypt the secured message and to access its contents. The sender and recipient are both assured that the message content was not available in cleartext on any machine except the sending and receiving machines.

The preferred embodiment uses the local process/agents on SENDER 1105 and CLIENT 1110 to make and serve the requests for public key information as well as to encrypt/decrypt the message contents. These processes/agents may be included in the heartbeat consumers/generators described above and the intermediary server may be included in the heartbeat generator. SENDER 1105, when it desires to send a secure message to CLIENT 1110, the local agent of SENDER 1105 queries server 1115 for the public key of CLIENT 1110. Server 1115 in turn queries CLIENT 1110 for a public key. In the preferred embodiment, each such query from server 1115 to CLIENT 1110 causes the local process/agent to generate a new public/private key pair without input from the user. Depending upon implementation, various levels of key strength and other parameter data may be set in advance by the user but it is preferred that CLIENT 1110 dynamically generate a new public/private key pair in response to each query and the public key is passed to SENDER 1105 through the secure channels used by server 1115 in its communications with the local processes. In some implementations, a second channel different than the primary messaging channel/protocol may provide sufficient security levels.

It is preferred that the dynamic generation includes some random or locally derived component that changes with some frequency in unpredictable ways to improve the quality of the generated key pairs. For example, real-time current disk capacity, file lists, process Ids or other locally unique and incalculable data are included in the key generation algorithm. In some cases, it may be necessary for server 1115 to assign an ID to the public key so CLIENT 1110 knows which key to use in decrypting any particular message. SENDER 1105 would mark the secured message with the ID associated with the public key it used and CLIENT 1110 would easily use the correct private key that corresponds to the public key used by SENDER 1105. After transmitting the secure message, SENDER 1105 discards the public key as it will not be reused and after decrypting the secured message, CLIENT 1110 discards the public and private key. Server 1115 does not store the public key information passed between the participants. In this way, it is very simple, convenient, and efficient to send secured messages and neither of the participants is required to have any familiarity with the intricacies of creating/generating/using public/private keys. Any copies of the message that exist in transit between SENDER 1105 and CLIENT 1110 are encrypted and require use of the private to easily decrypt, and that private key exists on CLIENT 1110, and only briefly. Successive messages to CLIENT 1110 will each require a different private key, further increasing the difficulty of accessing cleartext versions of the messages in transit.

In some embodiments, public/private keys may not be generated so frequently as on a per-message basis. In other implementations, a SENDER 1105 useable component may be generated by server 1115 and provided to SENDER 1105 and/or CLIENT 1110, or all necessary encryption components are generated by server 1115 and provided to the local processes/agents as necessary. In some instances, peer-to-peer exchange of public key information may be performed in lieu of an intermediary server. In some instances, a key pairs may be generated in advance during system idle time in preparation of a request from a sending station.

System 1100 may not be used exclusively for secure message transmission/receipt. System 1100 may also be used to provide an E-mail equivalent of a “CERTIFIED” delivery of an E-mail message. Some messaging systems employ an ability of a message sender to request a “READ RECEIPT” that is automatically generated by some messaging clients in response to a specific formatted request. When the user does not employ the particular client or has not enabled or has disabled the feature, the sender is unable to receive confirmation of a message delivery.

System 1100 may be used for SENDER 1105 to request a DELIVERY CERTIFICATE to a particular CLIENT 1110. Server 1110 generates a CERTIFICATE ID, provides the information to SENDER 1105 and CLIENT 1110 and when CLIENT 1110 receives the message with the CERTIFICATE, CLIENT 1110 notifies server 1115 which in turn notifies SENDER 1105. In some cases, certificate details (e.g., time/date, sender, recipient, certificate number, unique digital ID of message) may be retained and stored by server 1115.

System 1100 also permits, in the case of heartbeat consumption/generation (and/or public/private key pair encryption capabilities) by SENDER 1105, CLIENT 1110, and server 1115 to use heartbeats or key exchange in a peer-to-peer configuration in addition to client server exchanges. In this peer-to-peer configuration, any pair of local processes/agents may verify a communications channel between them (for example, when one device is a mobile or wireless device). In some instances two subscribers may desire to verify the existence of a communications channel between them and to provide heartbeats and to exchange other directives or public keys between them without use of server 1115. For some users, there may be multiple verified channels. In which case, the notification/indication system is configurable to display information about individual links or collections of links. In some instances, it is important for a sender to know that a message was received. The sender is configurable to have sender request verification of a particular message and client 1110 confirm that the message was, in fact received. In some cases, a message signature may be used to verify receipt of a complete transmission even when a certificate is not generated and retained.

It is appreciated that use of local processes/specially configured devices having the features disclosed herein that a communications system may default to sending secure messages by requesting whether the recipient has the ability to decrypt and read a transmitted encrypted message. When the test is positive, the encrypted message is sent and when the test is negative, a cleartext message is transmitted. In the preferred embodiment, the test may be done before starting the encryption process or the test is incorporated into the transmission process. A SENDER may interrogate the intermediary server or for peer-to-peer operation, it may ask CLIENT whether it is configured for decryption. (Note that the publication of a public key is not a sufficient condition to verify that the CLIENT is able to decrypt a message as the published public key may be invalid or the user may not have access to the decrypting software or may not remember the passphrase. The preferred embodiment thus determines, in real time, whether a prospective CLIENT can actually produce cleartext from transmitted encrypted message.

The test of the preferred embodiment may be “heartbeat return request with a “SECURE CONFIRM” directive sent to the CLIENT from the SENDER. Or, more simply, the SENDER may just request a dynamically generated single use machine-derived public key and, if it receives one, it encrypts and transmits. When no public key is provided, SENDER transmits the cleartext version of the message. As noted above, the request may be made to an intermediary or to the CLIENT. The public key may come from the intermediary or the CLIENT, SENDER does not need to discriminate among these various possibilities in determining whether to send a cleartext message or an encrypted message.

FIG. 12 and FIG. 13 describe configurations used in identification and control of incoming messages, particularly for separating desired messages from undesired messages. In summary, the SPAM control features of the present invention include assignment of a special e-mail address to a subscriber. For purposes of the following discussion, the SPAM control E-Mail address assigned is no.spam@spamsta.com and is preferably unique to each subscriber. The subscriber also has their regular E-Mail address, referred to herein as name@domain.com. This SPAM control E-Mail address is the address used by the subscriber in everyday Internet tasks and the regular E-Mail address is the mailbox being protected.

Thereafter, all incoming E-Mail is delivered to the SPAM control E-Mail address. An E-Mail message matching various access rules set up by the subscriber is forwarded from the SPAM control address to the regular address. Setting up the access rules is explained below in connection with FIG. 12 and a format for the E-Mail message forwarded to the subscriber is further described below in connection with FIG. 13.

Periodically, the destination mail server associated with the SPAM control address creates a digest of E-mail messages and forwards the digest to the subscriber for action. The subscriber replies to the digest-forwarding E-Mail message and includes message-processing directives. The destination mail server then processes the E-Mail messages according to the directives in the replied E-Mail message.

In some implementations, this digest may be formed by the destination mail server or other mail server (e.g., MS Exchange Server and the like) to produce digests for review by subscribers away from their primary computing system. A special review format for the digest may be thus prepared and sent to another address (or fax using E-Mail to Fax services) for the subscriber to determine whether any important messages are waiting for review or action.

FIG. 12 is a summary E-Mail Action list 1200 according to a preferred embodiment of the present invention. The destination mail server for the SPAM control address periodically prepares E-Mail Action list 1200 based upon an available set of processing options, some default configuration options of the subscriber, and the E-Mail messages in the SPAM control address Inbox. As shown, action list 1200 is a digest of E-Mail identification information 1205 (e.g., sender name and subject line or other relevant identifying information) and available processing directives (including in this example Add & Forward 1210, Forward 1215, Hold 1220, Delete 1225, and SPAM 1230). The digest is forwarded from the SPAM control destination server to the subscriber's regular E-Mail (e.g., to the regular mail destination mail server) on a schedule determined by the subscriber and/or the system. For example, once a day or when a threshold number of messages are present in the Inbox.

The digest is sent in HTML format with embedded controls—such as a set of directive checkboxes associated with each identified E-Mail message. The subscriber simply replies to the digest message with appropriately checked options for the desired directives to apply to each E-Mail message. The SPAM control destination mail server then receives the directives and applies them on a message-by-message basis.

The SPAM control destination mail server may preprocess some of the E-Mail messages according to subscriber options and may include any number of standard SPAM/Virus identification tools to move them to a deletion folder or premark them as SPAM or INFECTED in the digest. The results of any preprocessing are reflected in the prepared digest and the digest is forwarded to the subscriber for review. The directives available in the preferred embodiment include:
Add & Forward 1210 which adds the sender to the access list and forwards the message (all further e-mails from this sender are automatically forwarded until the address is removed from the access list.
Forward 1215 which forwards the message to the subscriber.
Hold 1220 which maintains the E-Mail message in the Inbox and will be represented in the next digest.
Delete 1225 moves the E-Mail message to the deleted message folder on the destination mail server and will be deleted after the expiration of the configured wait-before-delete period (this could be immediate).
SPAM 1230 moves the E-Mail message to the deleted message folder and all further messages from this sender are automatically treated as SPAM and processed according to the subscriber options (e.g., preprocessed as SPAM or moved/deleted without further review from the sender).

There has been various SPAM control applications developed to assist a user in managing a personal inbox in an E-Mail client. The preferred embodiment of the present invention moves some of the control and management to the server before it enters the Inbox of the users E-Mail client. This is particularly advantageous for POP3 protocol compliant systems but the present invention may be implemented in other types of systems. These systems attempt to identify mail into various categories, for example: good mail, bad mail, and unknown. The preferred embodiment may implement such a system at the server and, as configured by the user, may auto-forward good mail, hold unknown and bad mail, and include some or all of the held mail in the digest list. It may be enough that the digest includes the unknown mail and lists a number of blocked messages. It is an advantage that moving the SPAM control features into the destination mail server prior to access from a POP3 client does not require client-specific versions of the SPAM control software. Additionally, statistics and other beneficial attributes or processes may be combined or merged across multiple SPAM control addresses to improve performance.

It is a further feature of the preferred embodiment to provide extended directives for interacting with the SPAM control destination E-mail server and the E-Mail client used for accessing/reading/managing all the E-Mail messages. These directives are dependent upon specific options and features of the system, but permit the user to send E-Mail messages from the protected address to the SPAM control address and generate various digests and move messages from various available folders, as well as configuring the available options. It may be desirable in some cases to prepare periodic archives of messages and to store/forward them as determined by a user.

As noted above, a special format of the digest may be used as a summary of E-Mail messages waiting on a mail server and this digest may be made available in more convenient form (e.g., fax or electronic communication to portable electronic device) so that the subscriber may access whether any waiting messages should be attended to. Different priorities and different digests may be prepared and forwarded to various locations depending upon needs and configuration options of a particular implementation.

The access list produced by the SPAM control destination server may be used in others of the applications disclosed herein, such as for example, the peer-to-peer heartbeat feature, or other applications where a qualified list of trusted senders and denied senders may be advantageously used. Similarly, access lists from those applications may be used/merged into the SPAM control system.

FIG. 13 is a generic E-Mail message 1300 forwarded to a subscriber according to a preferred embodiment of the present invention. E-mail message 1300 forwarded from the SPAM control system described above includes a body 1305 having a “From” field 1310 that identifies the SPAM control address and a “Subject” field 1315 that includes the original subject of the forwarded message. A message content area 1320 includes the original content and any attachment files.

Further, message 1300 includes a footer with additional directives: ADD 1325 and SPAM 1330, among possibly others. In the case that the subscriber forwarded a message and it turned out to be something other than expected, the user may reply to the sender (which is the SPAM control destination server) and check the appropriate controls. For example, when the subscriber simply forwarded a message using the digest, and the message turns out to be a qualified sender, the subscriber may desire to ADD the sender to the access list. Or for example, when the subscriber forwarded a message (using forward or Add & Forward) and it turns out to be undesirable correspondence, the subscriber may replay and check the SPAM directive which will remove the sender from the access list when present and add the sender to the SPAM sender list for further processing consistent with elected options.

Additionally, message 1300 includes in the footer two additional Reply to controls: Reply to Sender 1335 and Reply to All 1340. Since the Sender/CC/BCC lists are not directly preserved in E-Mail message 1300, these controls permit the subscriber to easily reply to the sender, sender group. In some systems, this information may be preserved.

Although embodiments of the invention have been described primarily with respect to communications channels implemented using familiar communications systems like computer networks and telephone networks, many types of communications systems may benefit from features of the present invention. Providing a user with direct feedback of the availability of operational readiness of an electronic device beyond signaling availability of a reduced condition improve user experiences and satisfaction. The digest concept may be applied after a fashion to other communications systems. For example, in telephone systems using caller ID, a SPAM control number may create access lists and process incoming calls based upon the rules and the calling number. After a forwarded call, the subscriber may call the SPAM control number and provide directives for the immediately received call.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention, for example for the switching control, is as a routine in an operating system made up of programming steps or instructions resident in a memory of a computing system during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a preferred embodiment” or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Therefore the scope of the invention is to be determined solely by the appended claims.

What is claimed as new and desired to be protected by Letters Patent of the United States is:

1. In a communication network with user access via a plurality of communications devices, a distribution system for communications transmitted between the devices comprising:
a first destination mail server for receiving a plurality of e-mail messages addressed to a first E-Mail address, said first destination mail server creating an action list digest of said plurality of e-mail messages and forwarding said action list digest to a second E-Mail address; and
a second destination mail server for receiving said action list digest and permitting a reply of said action list digest from said second destination mail server to said first destination mail server to include control directives for processing of the e-mail messages on said first destination server identified in said action list digest.

2. In a distribution network with user access via a plurality of communication devices, a distribution method for communications transmitted between said devices, the method comprising:
a) receiving a plurality of e-mail messages addressed to a first E-Mail address at a first destination mail server
b) creating an action list digest of said plurality of e-mail messages;
c) forwarding said action list digest to a second E-Mail address;
d) receiving said action list digest at a second destination mail server for said second E-Mail address; and
e) replying to said action list digest to said first destination mail server, said reply including control directives for processing said e-mail messages on said first destination server identified in said action list digest.

3. A computer program having code recorded on a computer readable medium for distribution of communications in a distribution network with user access via a plurality of communications devices, said computer program comprising code implementing a communications distribution method, the method comprising: a) receiving a plurality of e-mail messages addressed to a first E-Mail address at a first destination mail server
b) creating an action list digest of said plurality of e-mail messages;
c) forwarding said action list digest to a second E-Mail address;
d) receiving said action list digest at a second destination mail server for said second E-Mail address; and
e) replying to said action list digest to said first destination mail server, said reply including control directives for processing said e-mail messages on said first destination server identified in said action list digest.
